(19) United States
(12) Patent Application Publication
(10) Pub. No.: US 2025/0135497 A1
(43) Pub. Date: May 1, 2025

(54) SYSTEM AND METHOD FOR MATERIALS RECOVERY USING A MOBILE MATERIALS RECOVERY FACILITY (MMRF)

(71) Applicant: WM Intellectual Property Holdings, L.L.C., Houston, TX (US)

(72) Inventors: Guillaume Chevrette, Anjou (CA); Vu Nguyen, Houston, TX (US); Jean Beaudoin, Mont-Royal (CA)

(73) Assignee: WM Intellectual Property Holdings, L.L.C., Houston, TX (US)

(21) Appl. No.: 18/927,375

(22) Filed: Oct. 25, 2024

Related U.S. Application Data
(60) Provisional application No. 63/545,708, filed on Oct. 25, 2023.

(51) Int. Cl. B07C 5/02; B07C 5/342; B07C 5/36

(52) U.S. Cl. CPC B07C 5/02; B07C 5/342; B07C 5/36; B07C 2501/0054; B07C 2501/0063

(57) ABSTRACT

A system and method for materials recovery using a mobile materials recovery facility (MMRF) are provided. The presently disclosed subject matter aims to replace manual sorting lines and techniques with a mobile, robotized sorting line to automate the separation by using, for example, cameras, artificial intelligence assisted hyperspectral material recognition algorithms, and/or other sensor technologies (such as optical, RADAR, SONAR, and/or LIDAR), for treatment and removal of contaminations in the recycling, organics and residues streams.

### RELATED APPLICATION

This application claims the benefit, and priority benefit, of U.S. Provisional Patent Application Ser. No. 63/545,708, filed Oct. 25, 2023, the disclosure and content of which is incorporated by reference herein in its entirety.

### BACKGROUND

### Field of the Invention

The presently disclosed subject matter relates generally to materials recovery, and more particularly, to a system and method for mobile materials recovery.

### Description of the Related Art

Public event organizers and service providers in areas where multi-family apartment complexes are located or dense urban areas where recycling collections are performed at a centralized point are currently seeking services and tools to reduce the carbon footprint of their collections and events and to increase landfill diversion due to their sustainability goals or initiatives. This trend is driven by the global environmental awareness of the population.

Waste management and recycling at these large private and public areas and at events in these areas is a major topic of concern. Many event organizers already have in place three-way collection bins on site (recycling, organics and residues) that are often misused by the public, e.g., tossing materials into the incorrect bin. Event organizers are then faced with materials that are difficult, if not impossible, to recycle, given the contamination of each of the three flow streams. No sorting center is equipped to effectively receive and process this excessively contaminated material.

To purify the three steams (that is, to generate only recyclables in the recyclable stream, only organics in the organics stream and only residues in the residues stream), some event organizers have set up on-site sorting lines, but these are manual and labor-intensive (problematic in these times of labor scarcity) and also not very efficient with very low recovery rates. Event organizers are also challenged with high volume generation levels during events, which makes it difficult or impossible to go thru 100% of materials unless the working team stays for a few days post-event.

Improvements in this field of technology are therefore desired.

### SUMMARY

Various illustrative embodiments of a system for materials recovery using a mobile materials recovery facility (MMRF) are provided herein.

In certain illustrative embodiments, a mobile sorting system for gathering and sorting recyclable materials can include a first mobile unit and a second mobile unit. The first mobile unit can include a first trailer and a material gathering unit at least partially disposed within the first trailer. The material gathering unit can include a pourer (such as a cart or bin tipper) configured to grasp a waste or recycling receptacle (such as a tote or small dumpster) and pour bags containing recyclable materials from the waste or recycling receptacle, a bag opener, a vibrating (or vibratory) feeder, and a conveyor (such as a conveyer belt) configured to transport the recyclable material from the first mobile unit to the second mobile unit. The second mobile unit can include a second trailer and a material sorting unit at least partially disposed within the second trailer. The material sorting unit can include a scanner (such as an artificial intelligence or “A.I.” scanner) configured to scan and identify material in the recyclable materials as it travels on a sorting conveyer and at least one robotic arm configured to grab material from the recycled materials based on identity and deposit the material into a designated sorting bin.

In certain aspects, the scanner can utilize computer software and is configured to sort the material based on one or more of commodity value, material efficiency, and physical characteristics comprising one or more of shape and weight. The scanner can utilize computer software and can be configured to adapt dynamically and sort the material based on the most economically valuable materials. The scanner can utilize computer software and can be configured to adapt dynamically and sort the material based on the materials that are easiest to process. The scanner can utilize computer software and can be configured to adapt dynamically and sort the material based on the materials that are quickest to process. The sorting bin can have at least one load cell disposed therein to measure the amount of material that has been processed in the sorting bin. The scanner can be configured to identify recyclable material, organic material and residual material, and to adjust sorting parameters for the system based on which material is being processed. The vibrating feeder can be configured to distribute the recyclable material over the entire width of the conveyor with no overlapping, and the scanner can be configured to identify the type of material in the recyclable material and to calculate its exact position on the conveyor and instruct the robotic arm to pick the identified material.

Various illustrative embodiments of a method for materials recovery using a mobile materials recovery facility (MMRF) are also provided herein.

In certain illustrative embodiments, a method for gathering and sorting recyclable materials can include: grasping a waste or recycling receptacle with a mechanical arm and depositing the contents of the waste or recycling receptacle into a bag opener located in a first trailer, wherein the contents of the waste or recycling receptacle comprise at least one of bagged and unbagged recyclable materials; opening any bags from the contents of the waste or recycling receptacle to release the bagged recyclable materials; depositing the recyclable material from the bag opener into a vibrating feeder; vibrating the recyclable material in the vibrating feeder; transferring the recyclable materials into a second trailer; scanning the recyclable materials using an optical scanner in or near the second trailer and identifying one or more components in the recyclable materials; grasping the identified one or more components with a robotic arm; and depositing the identified one or more components into a designated sorting bin.

### BRIEF DESCRIPTION OF THE DRAWINGS

FIG. 1 is a side view of a system for materials recovery using a mobile materials recovery facility, in accordance with an illustrative embodiment of the presently disclosed subject matter; and

FIG. 2 is a side view and an exploded side view of a system for materials recovery using a mobile materials recovery facility, in accordance with an illustrative embodiment of the presently disclosed subject matter.

While the presently disclosed subject matter will be described in connection with the preferred embodiment, it will be understood that it is not intended to limit the presently disclosed subject matter to that embodiment. On the contrary, it is intended to cover all alternatives, modifications, and equivalents, as may be included within the spirit and the scope of the presently disclosed subject matter as defined by the appended claims.

### DETAILED DESCRIPTION

Various illustrative embodiments of a system and method for materials recovery using a mobile materials recovery facility (MMRF) are provided herein.

In certain illustrative embodiments, the presently disclosed subject matter aims to replace manual sorting lines and techniques at public events with a mobile, robotized sorting line to automate the separation by using, for example, cameras, artificial intelligence assisted hyperspectral material recognition algorithms, and/or other sensor technologies (such as optical, RADAR, SONAR, and/or LIDAR), for treatment and removal of contaminations in the recycling, organics and residues streams.

In certain illustrative embodiments, the presently disclosed subject matter allows on-site sorting of multiple inbound material types collected in the various recovery bins deployed at an event site (such as a outdoor sporting event or concert venue), thus avoiding double handling with a collection truck, transport to a sorting center and subsequently, transport of the recyclable materials to conditioners. In other words, with such a mobile system, the transport step to a sorting center is thus avoided and a user can move directly from sorting to selective collection on-site to the conditioners of the materials.

In certain illustrative embodiments, the presently disclosed subject matter provides event organizers with an on-site sorting system and service able to treat and remove contamination from each of the material flow streams, and in addition, carry out a specific sorting of recyclable materials into distinct by-products. The result is to have separated the materials from selective collection, and also to remove from the flow of organic materials and the flow of final residues, the recyclable materials which may have been mistakenly deposited in the wrong container. This can increase the capture rate of targeted materials and improve the quality of the materials sorted. Some additional benefits are increased efficiency of material recovery generated during public events, enabling materials to be sorted directly on site, and helping public event organizers to achieve zero waste goals.

Moreover, in certain illustrative embodiments, there are additional benefits of waste characterization and data collection at these large outdoor events due to camera based technology that is configured for image detection and object classification, in that the collected data could be useful for the event for reporting purposes and to change waste management for better sustainability.

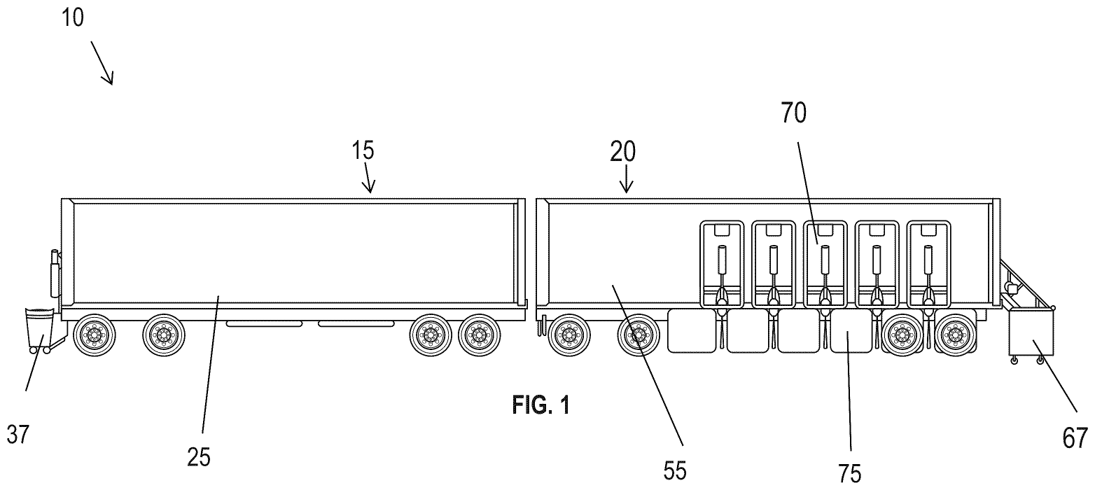

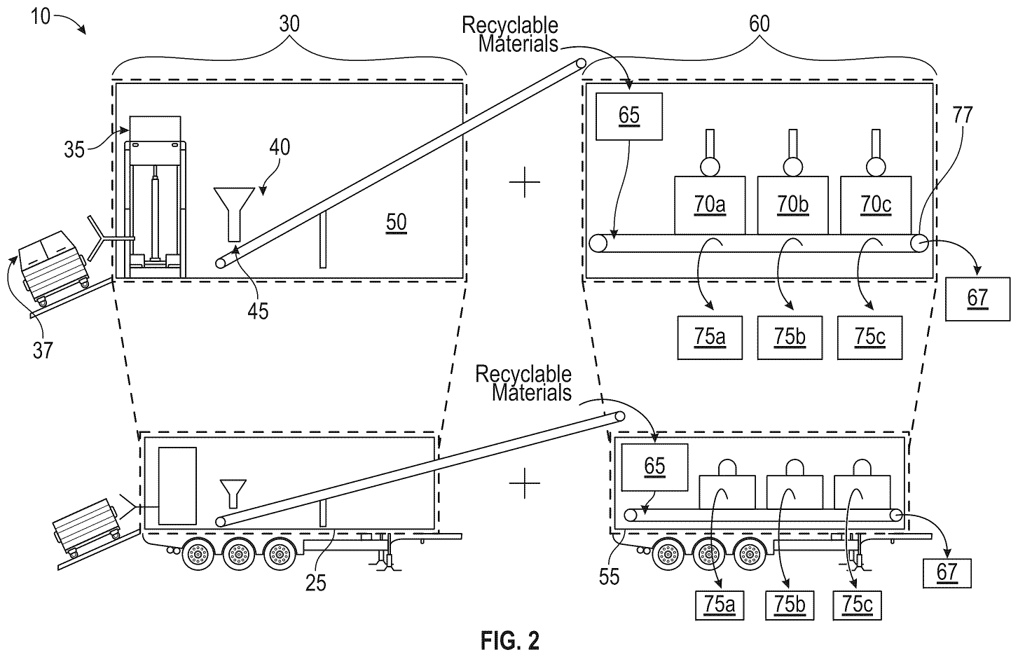

In certain illustrative embodiments, as shown in FIG. 1 (in a side view) and FIG. 2 (in side and exploded views), the mobile sorting system 10 for gathering and sorting recyclable materials can include a first mobile unit 15 and a second mobile unit 20. The first mobile unit 15 can include a first trailer 25 and a material gathering unit 30 at least partially disposed within the first trailer 25. The material gathering unit 30 can include a pourer or similar mechanical arm 35 (such as a cart or bin tipper) configured to grasp a waste or recycling receptacle 37 (such as a tote or small dumpster) and pour bags containing recyclable materials from the waste or recycling receptacle 37 into a bag opener 40 and a vibrating (or vibratory) feeder 45, and a conveyor 50 (such as a conveyer belt) configured to transport the recyclable material exiting the vibrating (or vibratory) feeder 45 from the first mobile unit 15 to the second mobile unit 20. The second mobile unit 20 can include a second trailer 55 and a material sorting unit 60 at least partially disposed within the second trailer 55. The material sorting unit 60 can include a scanner 65 (such as an artificial intelligence or “A.I.” scanner using optical scanning technology) configured to scan and identify material in the recyclable materials received from the first trailer 25 as they travel on a sorting conveyer 77 and at least one robotic arm 70 configured to grab material from the recycled materials based on identity and deposit the material into a sorting bin 75. In certain illustrative embodiments, system 10 can be fed manually or using automatic pourer 35.

In certain illustrative embodiment, the first trailer 25 and the second trailer 55 of the mobile sorting system 10 can be two or more large containers (approximately 45 feet each), such as, for example, sea containers. The first trailer 25 can be a front-end trailer used for the front-end gathering process. The second trailer 55 can be a back-end trailer used for the artificial intelligence vision system and can utilize a plurality (e.g., 5 to 6) of sorting robotic arms 70a, 70b, 70c, etc., for sorting purposes.

In certain illustrative embodiments, the first trailer 25 can allow an operator to load recyclable material to the sorting line using a pourer 35 (such as a cart or bin tipper) that has the flexibility for different size bins 37 containing recyclable material (bagged and/or unbagged). Then, the material can pass through a bag opener 40 to be liberated (especially if in bags), and material can be discharged onto a vibrating feeder 45 while the emptied bags are discharged into a separate receptacle. The vibrating feeder 45 can distribute the liberated material over the entire width of a conveyor 50 and in individual pieces with no overlapping. This material distribution can allow scanner 65 and associated artificial intelligence detection system in the second trailer 55 to correctly identify the type of material and to calculate its exact position on the conveyor 77 to have the robotic arm 70 to correctly pick the desired item. The vibrating feeder 45 will effectively liberate materials after the bag opener 40 as well as disperse materials onto conveyer 50 more evenly and in a mono and homogeneous layer. This dispersion method will make it easier for the scanner 65 and the associated artificial intelligence detection system in the second trailer 55 to identify the objects, reduce risk of over lapping and then physically remove the item with the robot arms 70.

In certain illustrative embodiments, the first trailer 25 can utilize precise metering and feeding of materials to ensure even distribution onto the sorting conveyer 77. The vibratory feeder 45 can be used to spread materials evenly across the width of the conveyer 50, preventing issues like rolling or overlapping, which could interfere with the sorting process. In certain illustrative embodiments, a load cell (not shown) can be utilized on a hopper in the first trailer 25 to monitor the material input, ensuring that the system 10 operates within optimal parameters. This front-end design is crucial for maintaining the stability of materials on the conveyer 50, allowing for more accurate scanning and sorting downstream.

In certain illustrative embodiments, the scanner 65 and associated artificial intelligence detection system in the second trailer 55 can analyze the material using algorithms and hyperspectral imagery recognition to provide directives to each individual sorting robotic arm 70. The positive sorted material (that is, the material fraction that can be picked by the robot arms 70) can be put in dedicated bins 75 by those arms 70, and the negative fraction of the material can continue on the conveyor 77 to the end of the line into a negative fraction bin 67.

In certain illustrative embodiments, the mobile sorting system 10 can utilize multiple robotic arms 70a, 70b, 70c, etc. . . . , designed to handle different types of materials more effectively. This can increase the efficiency of the sorting process by ensuring that each material type, whether it is a crumpled piece of plastic or a flat piece—is picked up by the most suitable robotic arm 70. The robotic arms 70a, 70b, 70c, etc. . . . can use a computer algorithm to decide which robotic arm 70 to deploy based on the material's shape and the desired outcome, such as minimizing contamination or maximizing recovery rates. This approach could also involve prioritizing the selection of materials based on their economic value.

In certain illustrative embodiments, the mobile sorting system 10 can utilize artificial intelligence and robotic technologies to efficiently sort recyclable, organic and residual materials. Each of the three (3) material streams can be processed separately and depending on which stream is being processing, adjustments can be made to system sorting parameters.

In certain illustrative embodiments, the recyclables stream can be processed through the automated line of system 10 to extract organic material and residue to reduce recycling stream contamination. Extracted organic material can be set aside for transport to an organics processing facility, while residue can be set aside for transport to a disposal facility. Cleaned up recyclables can be sent to one or more recycling facilities for further processing or sold directly to an end customer.

In certain illustrative embodiments, similar processes through the automated line of system 10 can be repeated for the organics stream. The system 10 can extract recyclables and residues from the stream. Extracted residues can be sent to a disposal facility, while extracted recyclables can be sent to a recycling facility for further processing. Cleaned up organics can be sent to an organics processing facility.

In certain illustrative embodiments, for the residue stream, the system 10 can extract recyclables and organic materials to increase landfill diversion. Extracted organics can be sent to an organics processing facility, while extracted recyclables can be sent to a recycling facility for further processing. After reducing the residue stream, the residue (post-sorting) can be sent to a disposal facility.

In certain illustrative embodiments, system 10 can be a mobile set up with self-sustained power (e.g., either via generator or on-site power with quick disconnect) for electrical needs and can be deployable in any public area with sufficient space, such as in the yards of any public events or underground parking. All mechanical components of system 10 can be hydraulically powered to facilitate in-field installation and reduce electricity consumption. In certain illustrative embodiments, only one hydraulic power pack can be needed to make the line run. In certain illustrative embodiments, system 10 can be contained in only two sea containers, thus allowing it to be transported and deployed even into very limited spaces.

In certain illustrative embodiments, the first trailer 25 and the second trailer 55 can be installed sequentially, one at the end of the other, and the system 10 can be installed after few manipulations. In certain illustrative embodiments, the system 10 can be run by two operators at the most. In certain illustrative embodiments, the first trailer 25 and the second trailer 55 can be also equipped with removable side panels that can be opened, so the public can see the robotic arms 70 in function, thus creating a new attraction and raising public awareness about the importance of recycling and eliminating contamination. The use of two trailers (such as the first trailer 25 for the front end process (infeed and metering) and the second trailer 55 for sorting and scanning) is a preferred embodiment, but a third, fourth or even additional trailers would bring additional sorting capabilities (for more commodities) and could also be utilized. Moreover, a single trailer with multiple compartments or functional sections could also be utilized without departing from the spirit and scope the presently disclosed subject matter.

In certain illustrative embodiments, the first trailer 25 can have both manual and automatic leveling systems. Proper leveling is beneficial not just for the first trailer 25 but also for the conveyer 50 and vibrating feeder 40, ensuring that all components remain flat and stable. An uneven conveyer 50 or trailer 25 could cause materials to shift, leading to sorting errors or equipment malfunction. In certain illustrative embodiments, the vibrating feeder 40 can walk off its position if not properly leveled, underlining the need for precise leveling mechanisms.

In certain illustrative embodiments, system 10 can be used to sort specific commodities, if needed. For example, aluminum cans are a valuable commodity that can be sorted by system 10. Moreover, given the extended producer responsibility (EPR) that is currently rolling out in many states/provinces, system 10 is not only suitable for public events, but also for a series of other applications such as high-density residential areas (multi-family), office towers, remote locations, shopping centers, airports, ports, etc. In certain illustrative embodiments, system 10 can also be used for material characterization audits, given that artificial intelligence technology can sort multiple grades for material.

In certain illustrative embodiments, final equipment specs for system 10 (e.g., conveyor width and speed, quantity of arms and sequence of sorting, etc) can be further defined upon testing and engineering. Additional testing can also be performed on the optical detection capabilities, validation of the robotic vision system and training of the hyperspectral and artificial intelligence model, the prehension device design and capacity of the arm robot, and validation of gripper protocol and adaptation to different materials.

In certain illustrative embodiments, system 10 can utilize one or more drip pans to manage any potential leakage, particularly liquids, to maintain cleanliness and prevent contamination of the materials being processed. System 10 can also utilize one or more load cells (not shown) in bins to monitor material distribution. The inclusion of load cells on the bins is designed to control material throughput more accurately, providing data on the amount of material being processed. Additionally, one or more chains or other mechanisms can be used to ensure that materials are evenly distributed across the sorting belt 77, minimizing overlap and maximizing the efficiency of the sorting process.

In certain illustrative embodiments, system 10 can utilize software that incorporates a decision tree that allows the sorting system to prioritize actions based on different criteria such as commodity value, material efficiency, or physical characteristics like shape and weight. This decision-making framework can enable the system 10 to adapt dynamically, either focusing on the most valuable materials (like aluminum) or optimizing throughput by choosing the materials that are easiest or quickest to process. The decision tree could also involve selecting materials that are larger or heavier first, allowing smaller items to be picked up more effectively later, thus reducing material waste and improving overall efficiency.

In certain illustrative embodiments, system 10 can be configured to generate detailed reports with specific materials tracking. For example, the reports can track specific brands of materials processed, such as distinguishing between Coca-Cola® and Pepsi® bottles. This capability would not only help meet diversion goals but could also offer brand owners detailed data on the recycling rates of their products. The system 10 could potentially track consumer behavior and waste patterns, thus providing valuable insights for companies interested in understanding how their products are being disposed of and recycled.

In certain illustrative embodiments, a method for gathering and sorting recyclable materials is provided. The method can include: grasping a waste or recycling receptacle 37 with a mechanical arm 35 such as a pourer and depositing the contents of the waste or recycling receptacle 37 into a bag opener 40 located in a first trailer 25, wherein the contents of the waste or recycling receptacle 37 comprise bagged and/or unbagged recyclable materials; opening any bags from the contents of the waste or recycling receptacle 37 to release the bagged recyclable materials; depositing the recyclable materials from the bag opener 40 into a vibrating feeder 45; vibrating the recyclable material in the vibrating feeder 45; transferring the recyclable materials into a second trailer 55; scanning the recyclable materials using an optical scanner 65 in or near the second trailer and identifying one or more components in the recyclable materials; grasping the identified one or more components with a robotic arm 70; and depositing the identified one or more components into a designated sorting bin 75. The scanning and identifying can be performed using optical scanning and artificial intelligence technologies.

In certain illustrative embodiments, a communications network 100 may be adapted for use in the system 10 of FIG. 1 and FIG. 2. For example, the system 10 can include a communications link between the various equipment components. The communications network 100 can include a plurality of data sources and a central server. Data sources may be, for example, devices configured for capturing and communicating operational data indicative of one or more operational characteristics of the system components and sharing information and operational instructions between the various components. Data sources are configured to communicate with a central server by sending and receiving operational data over a network (e.g., the Internet, an Intranet, or other suitable network).

In certain illustrative embodiments, the central server can be a local central server configured to process and evaluate the operational data received from data sources. Communications devices can be disposed on the system components. The communications devices and local central server are configured to communicate with each other via a communications network (e.g., the Internet, an Intranet, a cellular network, or other suitable network). In addition, communications device and central server are configured for storing data to an accessible central server database located on, or remotely from, the local central server.

In certain illustrative embodiments, the communication between the communications devices and the local and/or remote central server may be provided on a real time basis. Alternatively, communication devices may be configured to temporarily store or cache data and transfer the data to the desired central server.

In certain illustrative embodiments, system can also include one or more computer processors 150 which can be, for example, a standard desktop or laptop personal computer (“PC”), or a computing apparatus that is physically integrated with system 10. Computer 150 can also communicate with central server via a communications network.

In certain illustrative embodiments, central server can be configured to receive and store operational data from the various system components and evaluate the data to improve operational efficiency for system 10. Central server can include various means for performing one or more functions in accordance with embodiments of the present invention, including those more particularly shown and described herein; however, central server may include alternative devices for performing one or more like functions without departing from the spirit and scope of the present invention.

In certain illustrative embodiments, central server can include standard components such as processor and user interface for inputting and displaying data, such as a keyboard and mouse or a touch screen, associated with a standard laptop or desktop computer. Central server also includes a communication device for wireless communication with computer 150.

Central server may include software that communicates with one or more memory storage areas. Memory storage areas can be, for example, multiple data repositories which stores pre-recorded data. Database for data storage can be in memory storage area and/or supplementary external storage devices as are well known in the art.

While a “central server” is described herein, a person of ordinary skill in the art will recognize that embodiments of the present invention are not limited to a client-server architecture and that the server need not be centralized or limited to a single server, or similar network entity or mainframe computer system. Rather, the server and computing system described herein may refer to any combination of devices or entities adapted to perform the computing and networking functions, operations, and/or processes described herein without departing from the spirit and scope of embodiments of the present invention.

The presently disclosed subject matter has an number of advantages. For example, existing technologies have cross-contamination on customer-facing waste streams bins used during public events, which limits recycling environmental performances of the material as well as decreases the recovery of recycling and organic materials during those same events. By comparison, the presently disclosed subject matter can allow public event organizers to increase their environmental performances, to reduce carbon footprint of the activities, and to get toward zero waste events.

Moreover, recyclable streams can be cleaner, allowing a better recovery rate, and organics out of the system can also be cleaner and residues can be limited to what can't be recyclable or compostable. Having cleaner recyclable material in the recycling stream, and having cleaner organic material in the organic stream without contamination, can then reduce the residues fraction that is in those both streams. Based on other above potential applications, the presently disclosed subject matter could solve a multitude of existing problems related to space constraint, labor shortage, data collection needs, and landfill diversion targets among a few.

Existing technologies also have space, logistical and economical constraints to getting the material to a traditional MRF facility. By comparison, the presently disclosed subject matter provides space, logistical and economic improvements. For example, as to space, the presently disclosed subject matter can be a portable system that can be able to travel to sites on public roads, as well as provide an area for dedicated sorting at events that are often limited with space. As to logistics, in current conditions if there were any sort of separation occurring, that would be by a manual process, which involves complexity, potential error and safety concerns around deploying manual labor to sort through the stream. The presently disclosed subject matter alleviates these concerns. As to economics, the potential cost savings for automating and creating the presently disclosed mobile unit would give users a competitive advantage in bidding for these types of services.

In certain illustrative embodiments, the presently disclosed subject matter also provides an innovative way for recycling to take place at multi-family residences. Currently, recycling rates are low and contamination rates in general are high within the recycling stream from these sources. Education is the primary tool that is used to help battle the high contamination percentage. This technology due to its portability and innovative sorting capabilities can help manage the stream on-site, and produce a recyclable stream and residual stream that could go to a landfill.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter.

Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the non-provisional claims.

What is claimed is:

1. A mobile sorting system for gathering and sorting recyclable materials, comprising:
a first mobile unit and a second mobile unit,
the first mobile unit comprising:
a first trailer and a material gathering unit at least partially disposed within the first trailer, the material gathering unit comprising:
a pourer configured to grasp a waste or recycling receptacle and pour bags containing recyclable materials from the waste or recycling receptacle,
a bag opener,
a vibrating feeder, and
a conveyor configured to transport the recyclable material from the first mobile unit to the second mobile unit,
and the second mobile unit comprising:
a second trailer and a material sorting unit at least partially disposed within the second trailer, the material sorting unit comprising:
a scanner configured to scan and identify material in the recyclable materials, and
at least one robotic arm configured to grab material from the recycled materials based on identity and deposit the material into a sorting bin.

2. The mobile sorting system of claim 1, wherein the scanner utilizes computer software and is configured to sort the material based on one or more of commodity value, material efficiency, and physical characteristics comprising one or more of shape and weight.

3. The mobile sorting system of claim 1, wherein the scanner utilizes computer software and is configured to adapt dynamically and sort the material based on the most economically valuable materials.

4. The mobile sorting system of claim 1, wherein the scanner utilizes computer software and is configured to adapt dynamically and sort the material based on the materials that are easiest to process.

5. The mobile sorting system of claim 1, wherein the scanner utilizes computer software and is configured to adapt dynamically and sort the material based on the materials that are quickest to process.

6. The mobile sorting system of claim 1, wherein the sorting bin has at least one load cell disposed therein to measure the amount of material that has been processed in the sorting bin.

7. The mobile sorting system of claim 1, wherein the scanner is configured to identify recyclable material, organic material and residual material, and to adjust sorting parameters for the system based on which material is being processed.

8. The mobile sorting system of claim 1, wherein the vibrating feeder is configured to distribute the recyclable material over the entire width of the conveyor with no overlapping, and wherein the scanner is configured to identify the type of material in the recyclable material and to calculate its exact position on the conveyor and instruct the robotic arm to pick the identified material.

9. A method for gathering and sorting recyclable materials, comprising:
grasping a waste or recycling receptacle with a mechanical arm and depositing the contents of the waste or recycling receptacle into a bag opener located in a first trailer, wherein the contents of the waste or recycling receptacle comprise at least one of bagged and unbagged recyclable materials;
opening any bags from the contents of the waste or recycling receptacle to release the bagged recyclable materials;
depositing the recyclable material from the bag opener into a vibrating feeder;
vibrating the recyclable material in the vibrating feeder;
transferring the recyclable materials into a second trailer;
scanning the recyclable materials using an optical scanner in or near the second trailer and identifying one or more components in the recyclable materials;
grasping the identified one or more components with a robotic arm; and
depositing the identified one or more components into a designated sorting bin.
